(19) United States
(12) Patent Application Publication
(10) Pub. No.: US 2024/0193921 A1
(43) Pub. Date: Jun. 13, 2024

(54) APPARATUS FOR SELECTING LEARNING DATA, METHOD OF SELECTING LEARNING DATA, AND NON-TRANSITORY RECORDING MEDIUM

(71) Applicant: PFU LIMITED, Ishikawa (JP)

(72) Inventor: Kodai YAMANE, Ishikawa (JP)

(21) Appl. No.: 18/582,502

(22) Filed: Feb. 20, 2024

Related U.S. Application Data
(63) Continuation of application No. PCT/JP2021/031018, filed on Aug. 24, 2021.

(51) Int. Cl. G06V 10/774; G06V 10/778

(52) U.S. Cl. CPC G06V 10/774; G06V 10/7788

(57) ABSTRACT

An apparatus, a method, and a program stored in a non-transitory recording medium each of which acquires a data file, specifies an operation performed by a user on the acquired data file, and determines whether to adopt the acquired data file as learning data for machine learning based on the specified operation.

### CROSS-REFERENCE TO RELATED APPLICATIONS

This patent application is a continuation application of International Application No. PCT/JP2021/031018, filed on Aug. 24, 2021, in the Japan Patent Office, the entire disclosure of which is hereby incorporated by reference herein.

### BACKGROUND

### Technical Field

The present disclosure relates to an apparatus for selecting learning data, a method of selecting learning data, and a non-transitory recording medium.

### Related Art

Japanese Unexamined Patent Application Publication No. 2019-158684 discloses a test system that evaluates determination performances of a first discriminator before relearning or additional learning and a second discriminator after relearning or additional learning by using an evaluation data set, and that determines, based on a result of the evaluation, whether the determination performance of the second discriminator is deteriorated as compared with that of the first discriminator. When the determination performance of the second discriminator is deteriorated as compared with that of the first discriminator, the test system determines whether a product is good by using the first discriminator without using the second discriminator.

Japanese Unexamined Patent Application Publication No. 2020-194355 discloses a machine learning data collection system 3 including classification model holding means 22 for arranging a plurality of trained classification models to be used in a user environment 2; model distribution means 26 for distributing the classification models to the user environment 2; classification result holding means 23 for performing classification by using labeled data transmitted from the user environment 2 as an input and holding a classification result including classification propriety and a correct answer rate for each input data; optimum model recommendation means 21 for presenting, based on the classification result for each classification model, an appropriate classification model to the input data; and teacher data recording means 28 for recording the input data as teacher or test data of the classification model.

Japanese Unexamined Patent Application Publication No. 2018-124617 discloses a teacher data collection apparatus that collects data related to a specific filed to be used as teacher data for machine learning. The teacher data collection apparatus includes a feature calculation unit that calculates a first feature vector that is a feature vector of reference data related to a specific field registered in advance; a generation unit that generates, from the first feature vector, a search condition used to collect data related to the specific field; a collection unit that collects, based on the generated search condition, data related to the specific field; a similarity calculation unit that calculates, in response to the feature calculation unit calculating a second feature vector which is a feature vector of the collected data, a similarity between the second feature vector and the first feature vector; and an extraction unit that extracts, as the teacher data, the collected data having the similarity within a predetermined range.

### SUMMARY

According to an embodiment of the present disclosure, an apparatus for selecting learning data includes circuitry. The circuitry acquires a data file, specifies an operation performed by a user on the acquired data file, and determines whether to adopt the acquired data file as learning data for machine learning based on the specified operation.

According to an embodiment of the present disclosure, a method of selecting learning data includes acquiring a data file, specifying an operation performed by a user on the acquired data file, and determining whether to adopt the acquired data file as learning data for machine learning based on the specified operation.

According to an embodiment of the present disclosure, a non-transitory recording medium stores a plurality of instructions which, when executed by one or more processors, causes the processors to perform a method of selecting learning data including acquiring a data file, specifying an operation performed by a user on the acquired data file, and determining whether to adopt the acquired data file as learning data for machine learning based on the specified operation.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a general arrangement of an image processing system according to an embodiment of the present disclosure;

FIG. 2 is a view illustrating learning data of an orientation determination process according to an embodiment of the present disclosure;

FIG. 3 is a diagram illustrating a hardware configuration of an image processing server according to an embodiment of the present disclosure;

FIG. 4 is a diagram illustrating a functional configuration of the image processing server according to an embodiment of the present disclosure;

FIG. 5 is an image information table of data files stored in the image processing server according to an embodiment of the present disclosure;

FIG. 6 is a view illustrating a viewing and editing screen provided by a service providing unit according to an embodiment of the present disclosure;

FIG. 7 is a flowchart illustrating a learning process performed by the image processing server according to an embodiment of the present disclosure; and

FIG. 8 is a flowchart illustrating an adoption/rejection determination process of FIG. 7 according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

One or more embodiments of the present disclosure will be described below with reference to the drawings.

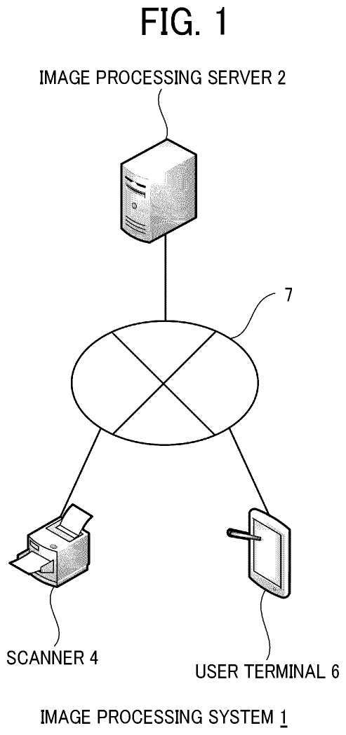

FIG. 1 is a diagram illustrating a general arrangement of an image processing system 1 according to an embodiment of the present disclosure.

As illustrated in FIG. 1, the image processing system 1 includes an image processing server 2, a scanner 4, and a user terminal 6, which are connected to each other via a network such as the Internet 7.

The image processing server 2 is, for example, a computer terminal, and performs image processing on an image file received from the scanner 4. The image processing server 2 is an example of a learning data selection apparatus (apparatus for selecting learning data) according to the present embodiment of the present disclosure.

The scanner 4 is an image reading apparatus that optically reads image data from a document (image display medium) and, for example, transmits a data file of the read image data (image file) to the image processing server 2 via the Internet 7. For example, the scanner 4 is a network scanner and directly connects to the network such as the Internet 7.

The user terminal 6 is a computer terminal operated by a user and is used to view and edit image data managed by the image processing server 2. The user terminal 6 is, for example, a mobile terminal such as a smartphone or a tablet terminal. The Internet 7 is an example of the network. A description will be given herein of a specific example in which image data is transmitted from the scanner 4 to the image processing server 2 via the Internet 7, but the present disclosure is not limited thereto. For example, an image file may be transmitted or received by wired connection using, for example, a universal serial bus (USB) cable, or an image file may be transmitted or received via a restricted network such as a local area network (LAN).

Alternatively, the image processing server 2 may be incorporated in the scanner 4.

The overview of the present disclosure will now be described.

In recent years, with the development of the technology of machine learning (in particular, deep learning), approaches to improving image processing accuracy through learning of a large amount of data have been common. For example, character images of various shape patterns are learned using a method called convolutional neural network (CNN) to determine correct orientations of characters, and orientations of images are corrected.

In machine learning, learning data accompanied with a true correct answer label (hereinafter referred to as useful learning data) is desired, and mixing of learning data accompanied with a false correct answer label hinders an increase in accuracy. However, collecting a large amount of data and manually or visually assigning true correct answer labels involve a great deal of labor. While it may be possible to efficiently collect data by using scanned images and orientation determination results of a user, it is not recommended to view the data of the user in terms of privacy protection.

Accordingly, there is a demand for a technique of selecting useful learning data with neither manual work nor image viewing.

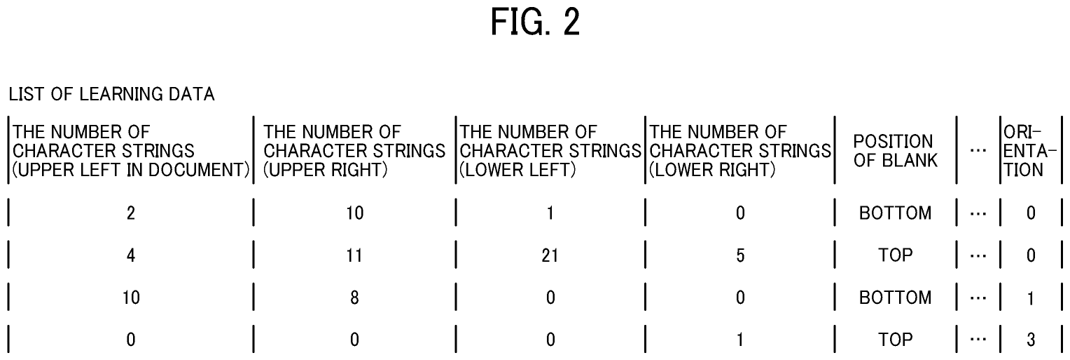

For example, the learning data is information illustrated in FIG. 2. Specifically, the learning data includes a plurality of data sets each including a plurality of explanatory variables indicating features of a document, and a correct answer label (in this case “orientation”) associated with the explanatory variables.

Collecting of such learning data involves the following issues.

It is difficult to select useful learning data from data files acquired from the cloud or a local area. That is, the acquired data includes data other than useful learning data.

Useful learning data herein corresponds to the following data example 1 and data example 2, and the other data corresponds to the following data example 3.

Data example 1: Data in which the orientation of an image has been corrected to a correct orientation (corrected data)

Data example 2: Data in which the orientation of an image is correct and has not been corrected (uncorrected data)

Data example 3: Data in which the orientation of an image is incorrect and has not been corrected (uncorrected data)

It is impossible to visually determine which of data example 2 and data example 3 is uncorrected data, for the following reasons.
(i) A rule does not allow a developer to view an image including personal information.
(ii) A large number of images makes a selection operation difficult.

When data example 3 is included in data used in machine learning, a false correct answer label is used in the learning, and thus the accuracy of an orientation determination process decreases. That is, discrimination between data example 2 and data example 3 in uncorrected data is an issue.

Accordingly, in the image processing system 1 according to the present embodiment, whether a data file is useful learning data is determined based on a user operation performed on the data file. The user operation performed on the data file is, for example, an operation performed by the user at the time of generating the data file, or an operation performed by the user at the time of viewing or editing the data file. In one example, the user operation performed on the data file is an operation performed on the scanner 4 by the user or an operation of viewing or editing an image performed on the user terminal 6 by the user. In the present embodiment, a specific example will be described in which a process of determining the orientation of an image is implemented by a machine learning model.

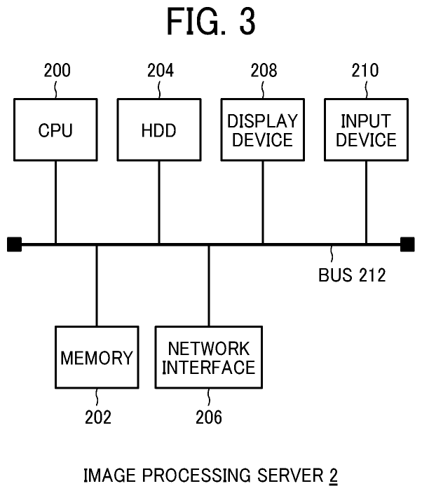

FIG. 3 is a diagram illustrating a hardware configuration of the image processing server 2 according to an embodiment of the present disclosure.

As illustrated in FIG. 3, the image processing server 2 includes a central processing unit (CPU) 200, a memory 202, a hard disk drive (HDD) 204, a network interface (IF) 206, a display device 208, and an input device 210. These components are connected to each other via a bus 212. The CPU 200 is, for example, a central processing unit.

The memory 202 is, for example, a volatile memory and functions as a main storage device.

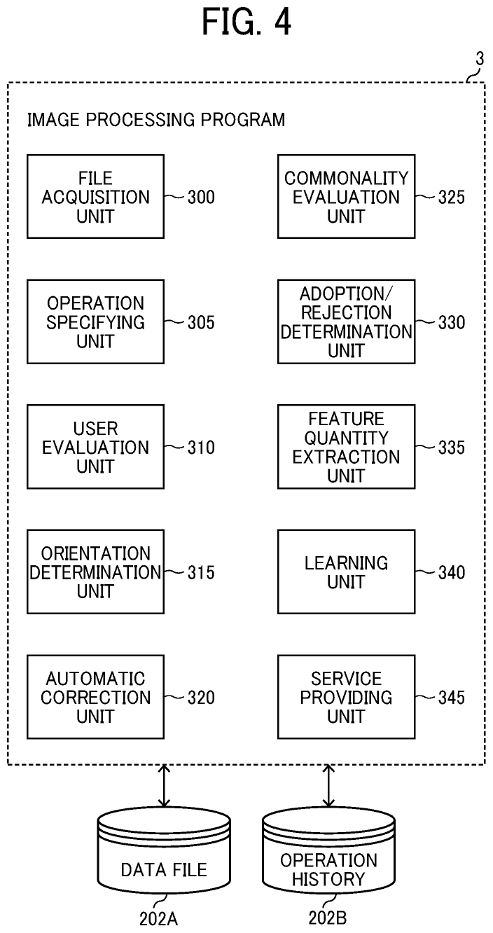

The HDD 204 is an example of a nonvolatile memory, which serves as a nonvolatile storage device that stores a computer program (e.g., an image processing program 3 illustrated in FIG. 4) and other data files.

The network IF 206 is an interface circuit for enabling wired communication or wireless communication, for example, to enable communication with the scanner 4 and the user terminal 6.

The display device 208 is, for example, a liquid crystal display.

The input device 210 includes, for example, a keyboard and a mouse.

FIG. 4 is a diagram illustrating a functional configuration of the image processing server 2 according to the embodiment of the present disclosure.

As illustrated in FIG. 4, in the present embodiment, the image processing program 3 is installed on the image processing server 2 to cause the image processing server 2 to operate according to the image processing program 3. The image processing program 3 is, for example, stored in a recording medium such as a compact disc read only memory (CD-ROM) and is installed on the image processing server 2 from the recording medium.

The image processing program 3 implements a file acquisition unit 300, an operation specifying unit 305, a user evaluation unit 310, an orientation determination unit 315, an automatic correction unit 320, a commonality evaluation unit 325, an adoption/rejection determination unit 330, a feature quantity extraction unit 335, a learning unit 340, and a service providing unit 345. Specifically, the CPU 200 executes the installed image processing program 3 to implement the functional units illustrated in FIG. 4.

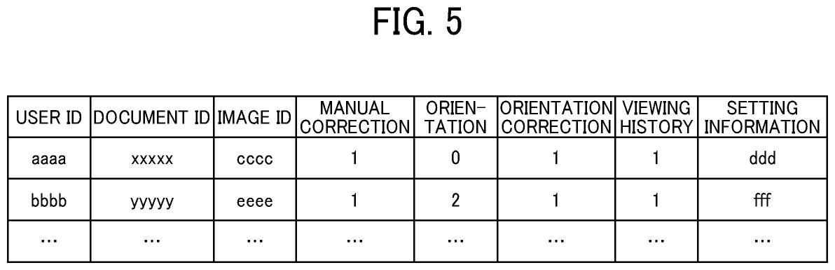

The image processing server 2 stores a data file (image file) received from the scanner 4 and an operation history of the data file. The information on the data file and the operation history are managed in the form of an image information table (described below with reference to FIG. 5). The data file may be stored in a data file database 202A illustrated in FIG. 4, such that the data files may be accumulated. The operation history, which may be in the form of the information management table, may be stored in an operation history database 202B illustrated in FIG. 4. The databases illustrated in FIG. 4 may be stored in the memory 202 illustrated in FIG. 3 or may be stored in an external memory.

In the present embodiment, a part or the entirety of the functional units illustrated in FIG. 4, each implemented by the image processing program 3, may be implemented by hardware such as an application specific integrated circuit (ASIC) or may be implemented by partially using the function of an operating system (OS).

The file acquisition unit 300 acquires a data file as a candidate for learning data. The file acquisition unit 300 of this example acquires, via the Internet 7, a data file including image data generated by the scanner 4. The acquired data file is stored in any desired memory of the image processing server 2.

The operation specifying unit 305 specifies a user operation performed on the data file acquired by the file acquisition unit 300. For example, the operation specifying unit 305 specifies a user operation performed on the data file acquired by the file acquisition unit 300, when the data file is generated or when the data file is viewed or edited. In one example, when the data file is generated, the operation specifying unit 305 specifies a setting operation performed on the scanner 4 or the number of sheets of a document set on the scanner 4, regarding the data file acquired by the file acquisition unit 300. In another example, when the data file is viewed or edited, the operation specifying unit 305 specifies a viewing operation or image editing operation performed on the user terminal 5, regarding the data file acquired by the file acquisition unit 300. The user operation specified by the operation specifying unit 305 is stored as an operation history at the image processing server 2, for example, in the image information table of FIG. 5.

The user evaluation unit 310 evaluates the reliability of the user based on the operation history of each user. The operation history for evaluating the reliability of the user includes, for example, the number of times an image is viewed, the ratio of the number of viewed images to the number of scanned images, the number of times the orientation of an image is manually corrected, the ratio of the number of times the orientation is manually corrected to the number of scanned images, the number of times of manual correction other than correction of the orientation of an image, and the ratio of the number of times of manual correction other than correction of the orientation to the number of scanned images. As the number or ratio of images viewed by the user increases, the user is more likely to check the orientations of images.

Similarly, as the number or ratio of manual corrections performed on images by the user increases, the user is more likely to check the orientations of images. The user evaluation unit 310 of this example multiplies the number or ratio of images by a predetermined weighting coefficient and evaluates the reliability of the user based on a value obtained through the multiplication.

The orientation determination unit 315 determines the orientation of an image in the data file acquired by the file acquisition unit 300. The orientation determination unit 315 determines the orientation of the image by using a machine learning model improved by the learning unit 340. As illustrated in FIG. 2, the machine learning model receives the numbers of character strings in individual regions (upper left, upper right, lower left, and lower right) of the image and the positions of blanks in the image.

The automatic correction unit 320 automatically performs a correction process on the data file acquired by the file acquisition unit 300. For example, the automatic correction unit 320 performs, in accordance with a setting operation performed on the scanner 4 by the user, an image orientation correction process, an image quality correction process, a blank removal process, and a cropping process on the data file acquired by the file acquisition unit 300. That is, the automatic correction unit 320 can switch between application or non-application of these automatic correction processes in accordance with the setting operation performed by the user.

The commonality evaluation unit 325 determines whether an operation of instructing to execute consecutive scanning processes (an operation of placing a plurality of document sheets on a document table of the scanner 4 and instructing scanning of the document sheets in one batch) has been performed. When it is determined that the operation of instructing to execute consecutive scanning processes has been performed, the commonality evaluation unit 325 evaluates the commonality of a plurality of data files generated by the plurality of scanning processes. Typically, document sheets scanned in one batch often have the same orientation. Thus, when data files are scanned in one batch and the commonality of the data files is high, the data files are determined to be useful learning data regardless of whether the user has viewed the data files. The commonality evaluation unit 325 determines whether the orientations of images included in the plurality of data files generated by one-batch scanning match each other based on a determination result made by the orientation determination unit 315.

The adoption/rejection determination unit 330 determines whether to adopt the data file acquired by the file acquisition unit 300 as learning data for machine learning based on the user operation specified by the operation specifying unit 305. The adoption/rejection determination unit 330 is an example of a determination unit according to the present disclosure. For example, the adoption/rejection determination unit 330 determines whether to adopt the data file as learning data, based on the user operation of viewing or correcting the image specified by the operation specifying unit 305 and the evaluation result made by the user evaluation unit 310. That is, the image viewed on the user terminal 6 by the user who has corrected the image using the user terminal 6 (a highly reliable user) is considered to be an image having a correct orientation checked by the user and is determined to be useful learning data.

The adoption/rejection determination unit 330 adopts, as learning data, a data file for which the operation specifying unit 305 has specified that a plurality of document sheets have been scanned in one batch and for which the commonality evaluation unit 325 has determined that the orientations of images match each other. In this example, the same document ID is assigned to data files read in one batch. Thus, the adoption/rejection determination unit 330 can determine whether to adopt the data files having the same document ID as learning data by comparing determination results of the orientation determination unit 315 (orientations) for the data files.

The adoption/rejection determination unit 330 adopts a data file as learning data when a setting operation of disabling an automatic correction process by the automatic correction unit 320 is specified by the operation specifying unit 305. For example, when a setting operation of disabling an orientation correction process is specified by the operation specifying unit 305, the adoption/rejection determination unit 330 adopts a data file generated through scanning with such setting as learning data. The data file generated through scanning performed with the scan setting of automatic orientation correction being disabled by the user is highly likely to be a data file generated through scanning performed by feeding paper in a correct orientation by the user, and can be determined to be useful learning data regardless of whether the user has viewed the data file.

The feature quantity extraction unit 335 extracts a feature quantity to be used as learning data from the data file adopted as learning data by the adoption/rejection determination unit 330. The feature quantity extraction unit 335 of this example extracts the numbers of character strings in individual regions (upper left, upper right, lower left, and lower right) of the image and the positions of blanks in the image.

The learning unit 340 performs machine learning for an orientation determination process by using the feature quantity of the data file adopted as learning data by the adoption/rejection determination unit 330. The learning unit 340 generates a machine learning model of the orientation determination process based on the feature quantity extracted by the feature quantity extraction unit 335 and the orientation of the image.

The service providing unit 345 displays or edits the data file acquired by the file acquisition unit 300 in response to the viewing operation or editing operation performed on the data file by the user. For example, the service providing unit 345 provides viewing or editing of the image file as a Web service in response to a request from the user terminal 6. Examples of the editing function provided to the user by the service providing unit 345 include an “inclination correction” function and a “trimming” function in addition to the image orientation correction function. The “inclination correction” function is a function used to correct an inclination (deviation) of several degrees that occurs when a document is scanned. The “trimming” function is a function used to cut out a part of an image. An assumption is made that the user checks the orientation of the image to some extent when using these functions, and the orientation of the image is added to candidates for features.

FIG. 5 illustrates an image information table of data files stored in the image processing server 2.

As illustrated in FIG. 5, the followings are registered in the image information table: a user ID identifying a user, a document ID identifying a document bundle (i.e., batch), an image ID identifying an image file, information indicating the details of manual correction, information indicating the orientation of an image, information indicating the details of automatic orientation correction, information indicating an image viewing history, and setting information indicating settings at the time of scanning. That is, when a data file (image file) is acquired by the file acquisition unit 300, the image processing server 2 registers the user ID, the document ID, the image ID, and the setting information in the image information table. When the orientation determination process is performed on the acquired data file, the image processing server 2 additionally registers a result of the orientation determination such as the orientation. When viewing, orientation correction, or manual correction is performed on the data file by the user, the image processing server 2 updates the viewing history, orientation correction, or manual correction in the image information table in accordance with the corresponding user operation.

The information indicating the details of manual correction is, for example, “−1: uncorrected, 0: orientation, 1: deletion, 2: others”. The information indicating the orientation of an image is information indicating a determination result made by the orientation determination unit 315 and is, for example, “−1: not determinable, 0: 0 degrees, 1: 90 degrees, 2: 180 degrees, 3: 270 degrees, 99: undetermined”. The information indicating the details of automatic orientation correction is information indicating the details of image orientation correction by the automatic correction unit 320 and is, for example, “−1: uncorrected, 0: 0 degrees, 1: 90 degrees, 2: 180 degrees, 3: 270 degrees”. The information indicating an image viewing history is, for example, “0: not viewed, 1: viewed”. The setting information indicating setting at the time of scanning is, for example, a difference from a default setting, and is information indicating the details of setting changed by the user.

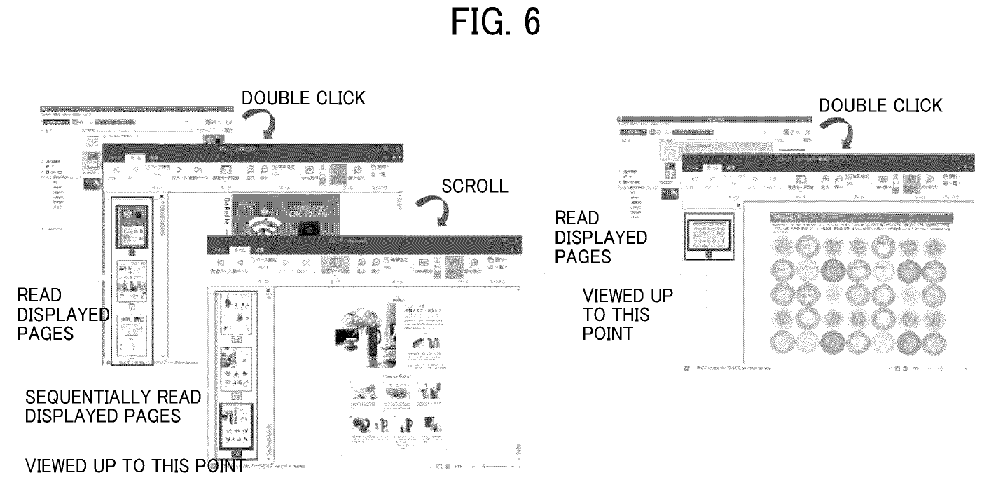

FIG. 6 is a view for describing a viewing and editing screen provided by the service providing unit 345, and operation for updating a viewing history of the image information table (FIG. 5). As illustrated in FIG. 6, in response to receiving a user instruction (for example, “double click” of a specific application), the service providing unit 345 causes the user terminal 6 to display a preview screen of images (in units of pages). In response to completion of reading of the image in the preview screen, the operation specifying unit 305 determines that the image has been viewed by the user and updates the “viewing history” information in the image information table (FIG. 5). At this time, only images of pages that are displayed in the preview screen of the user terminal 6, for example, by scrolling are read by the service providing unit 345. That is, an image of a page that is not displayed in the preview screen of the user terminal 6 is not read by the service providing unit 345. Accordingly, the probability that the user has checked increases for the read images.

When the user has performed manual correction (for example, correction of orientation or deletion) on the image (in units of pages) and stored the image on the user terminal 6, the operation specifying unit 305 determines that the user has performed an appropriate correction operation on the image. When the image has been corrected and stored, the operation specifying unit 305 updates the “manual correction” information in the image information table illustrated in FIG. 5.

When the orientation is corrected, the operation specifying unit 305 also updates the “orientation correction” information. In the present embodiment, the “orientation correction” information is not used to determine the usefulness of data, but is used for a correct answer label.

That is, at the startup of a viewer by the user terminal 6, the image processing server 2 reads an image file and updates the “viewing history” information for the read image file. Thereafter, when manual correction is performed by a user operation, the image processing server 2 updates the “manual correction” information. Every time a new page is displayed on an application by a scroll operation, the image processing server 2 repeats the above-described process.

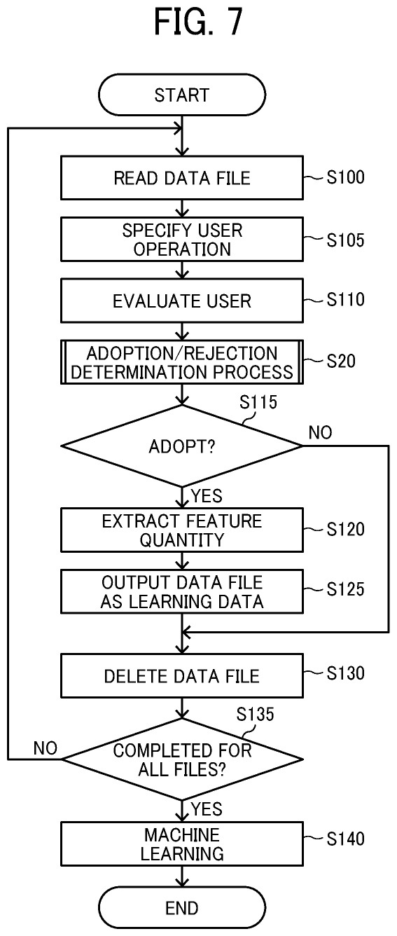

FIG. 7 is a flowchart illustrating a learning process performed by the image processing server 2. In this example, the learning process of FIG. 7 is performed periodically (once every two weeks). Further, selection of data to be input to the learning unit 340 and deletion of the accumulated image files are performed periodically. By selecting data to be input at the time of deleting the accumulated image files, duplication of learning data input to the learning unit 340 can be prevented.

As illustrated in FIG. 7, at step S100, the file acquisition unit 300 (FIG. 4) of the image processing server 2 reads an image file (data file), which has been read by the scanner 4. As described above referring to FIG. 6, the read image is stored in the data file database 202A, and the image information table of FIG. 5 is updated. For example, at this step, the file acquisition unit 300 reads an image file, from the image files stored in the data file database 202A.

At step S105, the operation specifying unit 305 refers to the image information table (FIG. 5) to specify a user operation performed on the image file read by the file acquisition unit 300.

At step S110, the user evaluation unit 310 refers to the image information table to specify the user associated with the image file that is read, and evaluates the reliability of the user based on the operation history of the specified user.

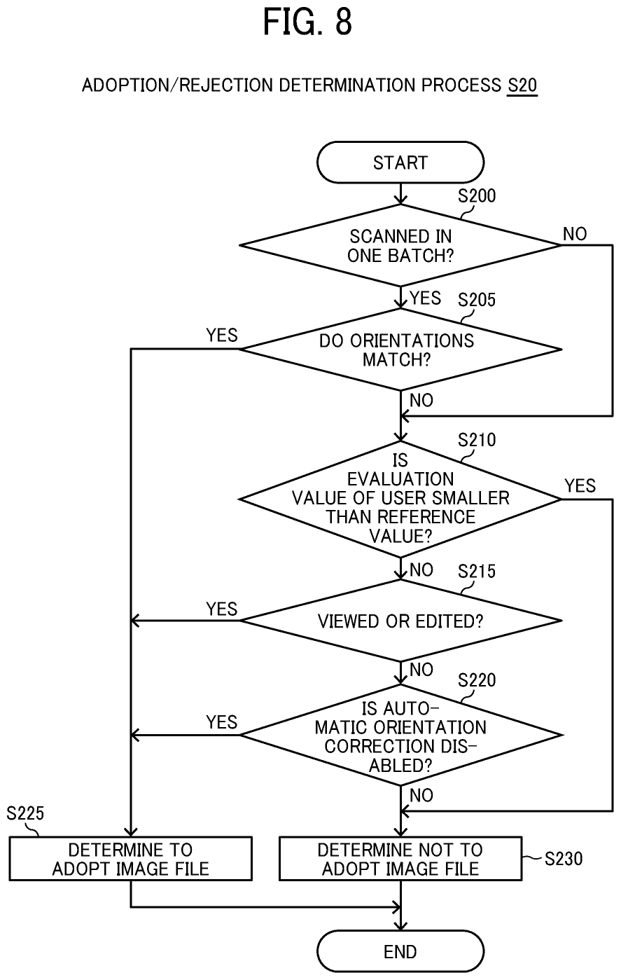

At step S20, the adoption/rejection determination unit 330 performs an adoption/rejection determination process illustrated in FIG. 8. The adoption/rejection determination unit 330 determines whether to adopt the image file read by the file acquisition unit 300 as learning data, based on the user operation specified by the operation specifying unit 305 and the reliability of the user evaluated by the user evaluation unit 310.

At step S115, the CPU 200 that operates under control of the image processing program 3 determines whether the image file is adopted or not based on the adoption/rejection determination process performed at S20. When it is determined that the image file is adopted as learning data by the adoption/rejection determination unit 330 (“YES” at S115), the operation proceeds to step S120. When it is determined that the image file is not adopted as learning data by the adoption/rejection determination unit 330 (“NO” at S115), the operation proceeds to step S130.

At step S120, the feature quantity extraction unit 335 extracts a feature quantity from the image file read by the file acquisition unit 300 at S100. At step S125, the feature quantity extraction unit 335 outputs the extracted feature quantity and a correct answer label (the orientation of the image), which is to be input to the learning unit 340 as learning data.

At step S130, the file acquisition unit 300 deletes the read image file, for example, from the data file database 202A.

At step S135, the CPU 200 that operates under control of the image processing program 3 determines whether the process has been completed for all of the image files stored in the data file database 202A. When it is determined that the process has been completed for all of the stored image files (“YES” at S135), the operation proceeds to step S140. When it is determined that there is an unprocessed image file (“NO” at S135), the operation returns to step S100 to read the next image file from the data file database 202A to repeat the above-described steps S105 to S135.

At step S140, the learning unit 340 generates a machine learning model for an orientation determination process by using the learning data received from the feature quantity extraction unit 335, and the operation ends.

FIG. 8 is a flowchart illustrating the adoption/rejection determination process of S20 in FIG. 7.

As illustrated in FIG. 8, at step S200, the adoption/rejection determination unit 330 refers to the image information table (FIG. 5) to determine whether the read image file is one of a plurality of image files scanned in one batch. The determination is made based on whether there is another image ID having the same document ID in the image information table. When the adoption/rejection determination unit 330 determines that the read image file is one of a plurality of image files scanned in one batch (“YES” at S200), the operation proceeds to step S205. Otherwise (“NO” at S200), the operation proceeds to step S210.

At step S205, the commonality evaluation unit 325 compares the plurality of image files scanned in one batch and determines whether the orientations of the images match each other. The determination of whether the orientations of the images match each other is made based on the “orientation” in the image information table (FIG. 5). When the commonality evaluation unit 325 determines that the orientations of the images match each other (“YES” at S205), the operation proceeds to step S225. When the commonality evaluation unit 325 determines that the orientations of the images do not match each other (“NO” at S205), the operation proceeds to step S210.

At step S210, the adoption/rejection determination unit 330 determines whether the evaluation value of the reliability evaluated by the user evaluation unit 310 is smaller than a reference value previously set. When the adoption/rejection determination unit 330 determines that the evaluation value of the reliability is smaller than the reference value (“YES” at S210), the operation proceeds to step S230. When the adoption/rejection determination unit 330 determines that the evaluation value of the reliability is equal to or larger than the reference value (“NO” at S210), the operation proceeds to step S215.

At step S215, the adoption/rejection determination unit 330 determines whether the read image file has been viewed or edited by the user. When the adoption/rejection determination unit 330 determines that viewing or editing has been performed (“YES” at S215), the operation proceeds to step S225. When the adoption/rejection determination unit 330 determines that neither viewing nor editing has been performed (“NO” at S215), the operation proceeds to step S220.

At step S220, the adoption/rejection determination unit 330 refers to the image information table (FIG. 5) to determine whether automatic orientation correction is disabled in the setting of the scanner 4. The determination of whether automatic orientation correction is disabled is made based on the setting information or the “orientation” information. When the adoption/rejection determination unit 330 determines that automatic orientation correction is disabled (“YES” at S220), the operation proceeds to step S225. When the adoption/rejection determination unit 330 determines that automatic orientation correction is enabled (“NO” at S220), the operation proceeds to step S230. When the user intentionally disables automatic orientation correction, it is determined that usability is high. However, even when the scan setting is disabled, it may be impossible to feed paper in an appropriate orientation depending on a document, and thus useful learning data is determined in consideration of user reliability.

At step S225, the adoption/rejection determination unit 330 determines to adopt the read image file as learning data. That is, the adoption/rejection determination unit 330 adopts an image file as learning data when the image file is scanned in one batch and all orientation determination results match, when the image file has been viewed or edited by a highly reliable user, or when automatic orientation correction is disabled by a highly reliable user.

At step S230, the adoption/rejection determination unit 330 determines not to adopt the read image file as learning data, and the operation ends.

As described above, in the image processing system 1 according to the present embodiment, an image file useful as learning data for an orientation determination process can be selected based on a user operation.

That is, learning data useful for machine learning can be selected without viewing a large number of images collected by a developer. As a result, stable learning can be performed, while increasing the accuracy in orientation determination.

The embodiment described above is given by way of example, and is not intended to limit the scope of the present disclosure. The above-described embodiment can be implemented in a variety of other forms. Various omissions, substitutions, and changes in the above-described embodiment can be made without departing from the gist of the disclosure. The above-described embodiment and the modification thereof are included in the scope and the gist of the disclosure, and also included in the invention described in the claims and the equivalent thereof.

Any one of the above-described operations may be performed in various other ways, for example, in an order different from the one described above.

The illustrated server is only illustrative of one of several computing environments for implementing the embodiments disclosed herein. For example, in some embodiments, the image processing server 2 includes a plurality of computing devices, e.g., a server cluster, which are configured to communicate with each other over any type of communications link, including a network, a shared memory, etc. to collectively perform the processes disclosed herein.

In a case where the image processing server 2 includes the plurality of computing devices, the plurality of computing devices can be configured to share the processing steps disclosed, e.g., in FIG. 7 or 8, in various combinations.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An apparatus for selecting learning data, the apparatus comprising circuitry configured to:
acquire a data file;
specify an operation performed by a user on the acquired data file; and
determine whether to adopt the acquired data file as learning data for machine learning based on the specified operation.

2. The apparatus according to claim 1, wherein the circuitry is configured to:
evaluate reliability of the user based on an operation history of the user; and
determine whether to adopt the acquired data file as the learning data based on the reliability of the user in addition to the specified operation.

3. The apparatus according to claim 2, wherein the circuitry is configured to:
determine whether an operation of instructing to execute a plurality of consecutive scanning processes has been performed for the acquired data file being generated; and
based on a determination that the operation of instructing to execute the plurality of consecutive scanning processes has been performed,
evaluate commonality of a plurality of data files generated by the plurality of scanning processes, the plurality of data files including the acquired data file, and
determine whether to adopt the acquired data file as the learning data based on an evaluation result of the commonality.

4. The apparatus according to claim 2, wherein the circuitry is configured to
specify, as the specified operation, a setting operation performed by the user for the acquired data file being generated, and
determine whether to adopt the acquired data file as the learning data based on the specified operation.

5. The apparatus according to claim 4, wherein
the acquired data file includes data of an image, and
the circuitry is configured to determine whether to adopt the acquired data file as the learning data, the learning data to be used for an orientation determination process of determining orientation of the image included in the data file.

6. The apparatus according to claim 5, wherein the circuitry is configured to:
specify, as the specified operation, a viewing operation or a correction operation performed on the image included in the data file;
determine whether to adopt the acquired data file as the learning data based on the specified viewing operation or the specified correction operation; and
perform machine learning for the orientation determination process by using a feature quantity of the data file adopted as the learning data.

7. The apparatus according to claim 3, wherein the circuitry is configured to:
determine whether orientations of images included in the plurality of data files match each other;
adopt at least two data files of the plurality of data files that are determined to include images having orientations that match each other, as the learning data; and
perform machine learning for an orientation determination process by using a feature quantity of each of the at least two data files adopted as the learning data.

8. The apparatus according to claim 4, wherein the circuitry is configured to
specify, as the specified operation, a setting operation indicating a setting of an automatic correction process, and
determine to adopt the data file as the learning data when the specified setting operation indicates disabling of the automatic correction process.

9. The apparatus according to claim 8, wherein the circuitry is configured to:
specify, as the specified operation, a setting operation indicating a setting of an orientation correction process of the data file;
determine to adopt the data file as the learning data when the specified setting operation indicates disabling of the orientation correction process; and
perform machine learning for an orientation determination process by using a feature quantity of the data file adopted as learning data.

10. A method of selecting learning data, comprising:
acquiring a data file;
specifying an operation performed by a user on the acquired data file; and
determining whether to adopt the acquired data file as learning data for machine learning based on the specified operation.

11. A non-transitory recording medium storing a plurality of instructions which, when executed by one or more processors, causes the processors to perform a method of selecting learning data, the method comprising:
acquiring a data file;
specifying an operation performed by a user on the acquired data file; and
determining whether to adopt the acquired data file as learning data for machine learning based on the specified operation.
